(19) United States
(12) Patent Application Publication
(10) Pub. No.: US 2006/0236609 A1
(43) Pub. Date: Oct. 26, 2006

(54) Variable geometry reactors

(76) Inventors: Mark A. Brundage, Pittsford, NY (US); Gerald E. Voecks, La Crescenta, CA (US)

Correspondence Address: CARY W. BROOKS;General Motors Corporation, Legal Staff, Mail Code 482-C23-B21, P.O. Box 300, Detroit, MI, 48265-3000, US

(21) Appl. No.: 11/113,483

(22) Filed: Apr. 25, 2005

(51) Int. Cl. B01J 8/00

(52) U.S. Cl. 48/198.3; 48/128; 48/127.9

(57) ABSTRACT

Reactors and methods for reducing the carbon monoxide concentration in a reactant stream are provided. The reactors are generally configured such that the gas hourly space velocity of the reactors increases along a reactant flow path between inlets and outlets of the reactors. The reactors may have preferential oxidation catalysts disposed along a reactant flow path.

### BACKGROUND OF THE INVENTION

The present invention relates to reactors and methods for carbon monoxide clean up. More particularly, the present invention relates to preferential oxidation (PrOx) reactors having reactant flow paths configured such that the gas hourly space velocity of the reactor increases along the reactant flow path and methods of removing carbon monoxide from a reactant stream employing such reactors.

Hydrogen fuel cells have become an increasingly attractive source of power for a variety of applications. However, the storage, transportation, and delivery of hydrogen presents a number of difficulties. Thus, hydrogen fuel cell systems may be equipped with reforming systems for producing hydrogen from an alternate fuel source such as a hydrocarbon fuel. However, these reforming systems often require extensive carbon monoxide removal subsystems because hydrogen fuel cells are generally not tolerant of carbon monoxide. The carbon monoxide removal systems may not effectively remove a desired amount of carbon monoxide.

Thus, there remains a need in the art for carbon monoxide clean-up subsystems that are more effective.

### SUMMARY OF THE INVENTION

In accordance with an embodiment of the present invention, a device comprising a reactor defined by a length, an inlet, and an outlet is provided. The reactor comprises a reactant flow path between the inlet and the outlet, and the reactor further comprises at least one preferential oxidation catalyst disposed along the length of the reactor. The reactant flow path is configured such that a reactant stream may flow along the length of the reactor from the inlet to the outlet. The reactant flow path is configured such that the reactant stream may contact the at least one preferential oxidation catalyst, and the reactant flow path is configured such that the gas hourly space velocity of the reactor increases along the reactant flow path between the inlet and the outlet.

In accordance with another embodiment of the present invention, a method for removing carbon monoxide from a reactant stream is provided. The method comprises providing a reactor defined by a length, an inlet, and an outlet and flowing a reactant stream comprising carbon monoxide, hydrogen, and oxygen through the reactor from the inlet to the outlet such that the concentration of carbon monoxide in the reactant stream is reduced between the inlet and the outlet. The reactor comprises a reactant flow path between the inlet and the outlet, and the reactor further comprises at least one preferential oxidation catalyst disposed along the length of the reactor. The reactant flow path is configured such that a reactant stream may flow along the length of the reactor from the inlet to the outlet, and the reactant flow path is configured such that the reactant stream may contact the at least one preferential oxidation catalyst. The reactant flow path is configured such that the gas hourly space velocity of the reactor increases along the reactant flow path between the inlet and the outlet.

In accordance with yet another embodiment of the present invention, a preferential oxidation reactor comprising a reactor defined by a length, an inlet, and an outlet is provided. The reactor comprises a reactant flow path between the inlet and the outlet. The reactor further comprises at least one preferential oxidation catalyst disposed along the length of the reactor. The reactant flow path is configured such that a reactant stream may flow along the length of the reactor from the inlet to the outlet, and the reactant flow path is configured such that the reactant stream may contact the at least one preferential oxidation catalyst. The reactant flow path is configured such that the gas hourly space velocity of the reactor increases along the reactant flow path between the inlet and the outlet. The reactor defines a conical shape between the inlet and the outlet. The reactant flow path extends along the conical shape from the inlet to the outlet, and the conical shape defines a taper angle θ of between about 75° and about 85°.

### BRIEF DESCRIPTION OF THE SEVERAL VIEWS OF THE DRAWINGS

The following detailed description of the preferred embodiments of the present invention can be best understood when read in conjunction with the following drawings, where like structure is indicated with like reference numerals and in which:

FIG. 1 is schematic illustration of a fuel cell system in accordance with the present invention.

FIG. 2 is an illustration of a reactor in accordance with an embodiment of the present invention.

FIG. 3 is an illustration of a reactor in accordance with another embodiment of the present invention.

FIG. 4 is an illustration of a reactor in accordance with yet another embodiment of the present invention.

FIG. 5 is an illustration of a reactor in accordance with another embodiment of the present invention.

FIG. 6 is a schematic illustration of a vehicle having a fuel processing system and an electrochemical reaction cell in accordance with the present invention.

### DETAILED DESCRIPTION OF THE PREFERRED EMBODIMENTS

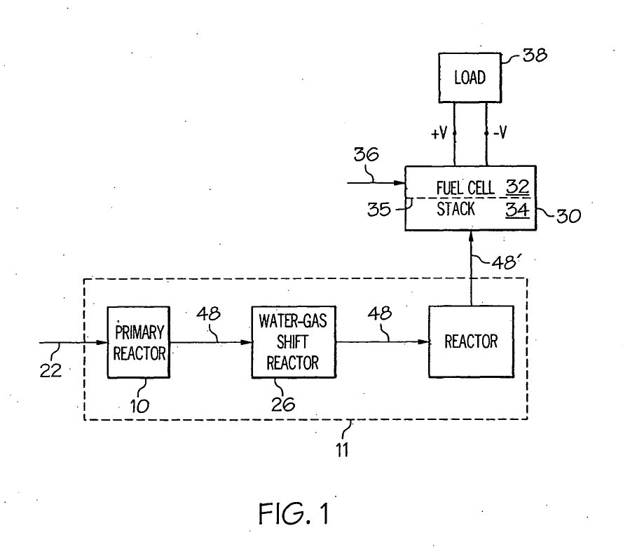

FIG. 1 illustrates an exemplary fuel cell system comprising a fuel processing system 11 with a primary reactor 10, a water-gas shift reactor 26, and a reactor 28. The fuel processing system 11 provides the fuel cell stack 30 with a source of hydrogen. In the primary reactor 10, a reactant mixture 22 that may contain a hydrocarbon fuel stream and an oxygen-containing stream is flowed into the primary reactor 10. The oxygen-containing stream may comprise air, steam, and combinations thereof. The reactant mixture 22 may be formed by mixing a hydrocarbon fuel with a preheated air and steam input stream before flowing the reactant mixture into the primary reactor. After the reactant mixture 22 is flowed into the primary reactor 10, the reactant mixture 22 passes over at least one reaction zone having at least one reforming catalyst and reactant stream 48 containing hydrogen is produced catalytically. The primary reactor 10 is generally an autothermal reactor in which hydrogen is produced by combined catalytic partial oxidation and steam reforming reactions but may alternatively comprise any suitable reactor configuration.

In one embodiment, the reactant gas stream 48 exiting the primary reactor 10 may comprise hydrogen and carbon monoxide. The reactant gas stream 48 exiting the primary reactor 10 may further comprise carbon dioxide, trace compounds, and water in the form of steam. To reduce carbon monoxide and increase efficiency, reactant gas stream 48 may enter a water gas-shift reactor 26. Oxygen from introduced water converts the carbon monoxide to carbon dioxide leaving additional hydrogen. The further reduction of carbon monoxide to acceptable concentration levels takes place in reactor 28. The reactor 28 will be discussed in detail hereinafter.

The carbon monoxide purged product stream 48′ exiting the reactor 28 is then fed into a fuel cell stack 30. As used herein, the term fuel cell stack refers to one or more fuel cells to form an electrochemical energy converter. As is illustrated schematically in FIG. 1, the electrochemical energy converter may have an anode side 34 and a cathode side 32 separated by diffusion barrier layer 35. The carbon monoxide purged product stream 48′ is fed into the anode side 34 of the fuel cell stack 30. An oxidant stream 36 is fed into the cathode side 32. The hydrogen from the carbon monoxide purged product stream 24′ and the oxygen from the oxidant stream 36 react in the fuel cell stack 30 to produce electricity for powering a load 38. A variety of alternative fuel cell designs are contemplated be present invention including designs that include a plurality of anodes 34, a plurality of cathodes 32, or any fuel cell configuration where hydrogen is utilized in the production of electricity.

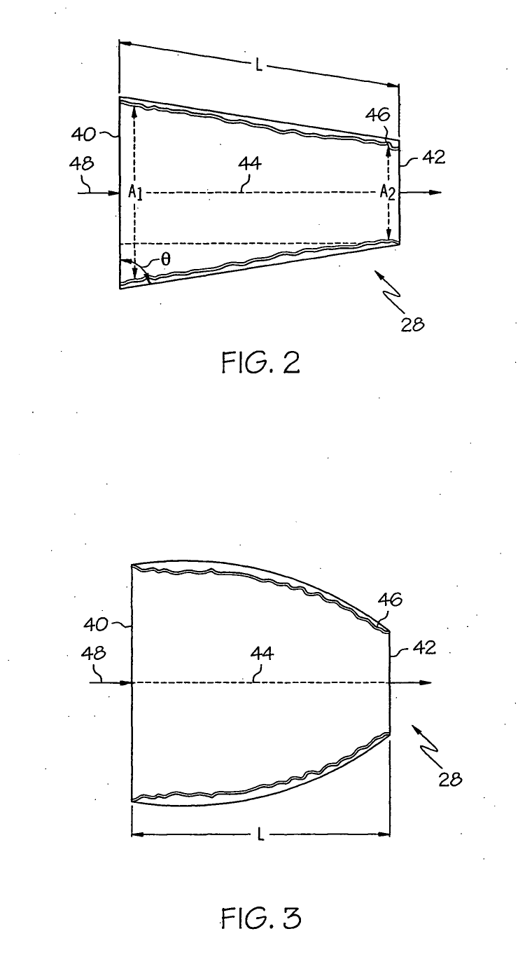

Referring to FIGS. 2-5, a device comprising a reactor 28 is provided. The reactor 28 is defined by a length L, at least one inlet 40, and at least one outlet 42. The reactor 28 has at least one reactant flow path 44 between the inlet 40 and the outlet 42, and the reactant flow path 44 is configured such that a reactant stream 48 may flow along the length of the reactor 28 from the inlet 40 to the outlet 42. Although the reactant flow path 44 is illustrated as a single line between the inlet 40 and the outlet 42, it will be understood that the reactant flow path 44 extends along the length L of the reactor 28 in the space between the inlet 40 and the outlet 42. Thus, the reactant flow path 44 generally extends along the volume of the reactor 28.

At least one preferential oxidation catalyst 46 is disposed along the length L of the reactor 28, as illustrated in FIGS. 2 and 3. The preferential oxidation catalyst 46 may be any suitable preferential oxidation catalyst. For example, the preferential oxidation catalyst may be selected from platinum, platinum alloys, noble metal catalysts, any other suitable oxidation catalyst, and combinations thereof. The reactant flow path 44 is configured such that the reactant stream 48 may contact the preferential oxidation catalyst 46. Reactant stream 48 generally comprises carbon monoxide and hydrogen. Additionally, reactant stream 48 may comprise oxygen.

A preferential oxidation reaction of the carbon monoxide (CO) in the reactant stream 48 generally occurs in the reactor 28 when the reactant stream 48 contacts the preferential oxidation catalyst. The preferential oxidation of CO may be described as CO+½O₂→CO₂. Thus, the concentration of CO in the reactant stream 48 is reduced as the reactant stream 48 flows along the reactant flow path 44 between the inlet 40 and the outlet 42. The preferential oxidation catalyst is also active for hydrogen (H₂) oxidation, which may be described as H₂+½O₂→H₂O. An undesirable reaction in a preferential oxidation reactor is the equilibrium driven reverse-water-gas-shift (RWGS) reaction, which may be described as CO₂+H₂ [symbol] H₂O+CO. Thus, as the oxygen present in the reactant stream 48 reacts with CO and H₂, the equilibrium of the RWGS reaction is shifted in the direction of the production of undesirable carbon monoxide.

The reactant flow path 44 is configured such that the gas hourly space velocity (GHSV) of the reactor 28 increases along the reactant flow path 44 between the inlet 40 and the outlet 42. For purposes of defining and describing the present invention, the term “GHSV” shall be defined as referring to a measure of the volumetric flow rate (volume/time) at standard temperature and pressure (STP) of 0° C. and 1 atm of a reactant stream divided by the volume of the reactor. It will be understood that the GHSV may be measured at a desired point along the reactant flow path 44. It will be further understood that the GHSV may also be measured for the entire reactor 28. Because reactor 28 has a reactant flow path 44 that is configured such that the GHSV of the reactor increases along the reactant flow path 44 between the inlet 40 and the outlet 42, the RWGS reaction is limited because the reactant stream 48 is in the reactor 28 for less time as the preferential oxidation reaction occurs along the length L of the reactor 28. The GHSV of the reactor 28 may continuously increase along the reactant flow path 44 between the inlet 40 and the outlet 42, and the GHSV of the reactor 28 may increase linearly along the reactant flow path 44 between the inlet 40 and the outlet 42.

As illustrated in FIGS. 2-5, the reactant flow path 44 may be configured such that a volume of the reactant flow path 44 taken along a predetermined length of the reactant flow path 44 decreases along the reactant flow path 44 between the inlet 40 and the outlet 42. Thus, the GHSV of the reactor 28 increases along the reactant flow path 44 because the volume of the reactant flow path 44 decreases. Additionally as illustrated in FIG. 1, the reactant flow path 44 may have a cross-sectional area along the reactant flow path 44. The cross-sectional area A₁ of the reactant flow path 44 proximate to the inlet 40 may be larger than the cross-sectional area A₂ of the reactant flow path 44 proximate to the outlet 42. Thus, the GHSV of the reactor 28 increases between the inlet 40 and the outlet 42 because the cross-sectional area of the reactor decreases between the inlet 40 and the outlet 42.

Referring to FIGS. 2-5, the reactor 28 may be configured such that the reactant stream 48 is characterized by a residence time profile along the reactant flow path 44. The residence time profile will be understood as referring to the residence time of the reactant stream 48 at a given point along the reactant flow path 44. The residence time value of the residence time profile may decrease along the reactant flow path 44 from the inlet 40 to the outlet 42, and the GHSV correspondingly increases along the reactant flow path from the inlet 40 to the outlet 42.

It will be understood that the reactor 28 may have a number of shapes that are suitable for the reactors of the present invention. Referring to FIG. 2, the reactor 28 may define a conical shape between the inlet 40 and the outlet 42, and the reactant flow path 44 may extend along the conical shape from the inlet 40 the outlet 42. For purposes of defining and describing the present invention, “conical shape” shall be understood as referring to a shape having the form of, or resembling, a geometrical cone. Thus a conical shape will generally be round and tapering to or toward a point, or gradually lessening in circumference. For example, the conical shape may be a flat cone as illustrated in FIG. 2, wherein the conical shape does not taper to a point. The conical shape may define a taper angle θ as shown in FIG. 2. The taper angle θ may be varied. For example, the taper angle θ may be less than about 90°, less than about 85°, or between about 75° and about 85°.

Referring to FIG. 3, the reactor 28 may define a curved conical shape between the inlet 40 and the outlet 42. The reactant flow path 44 may extend along the curved conical shape from the inlet 40 and the outlet 42. It will be understood that the reactor 28 may also define a pyramidal shape. For purposes of defining and describing the present invention, “pyramidal shape” shall be understood as referring to a shape having the form of, or resembling, a pyramid. The term “pyramid” shall be understood as referring to a shape having at least one flat side and tapering to or toward a point. The pyramidal shape may have three sides or more than three sides.

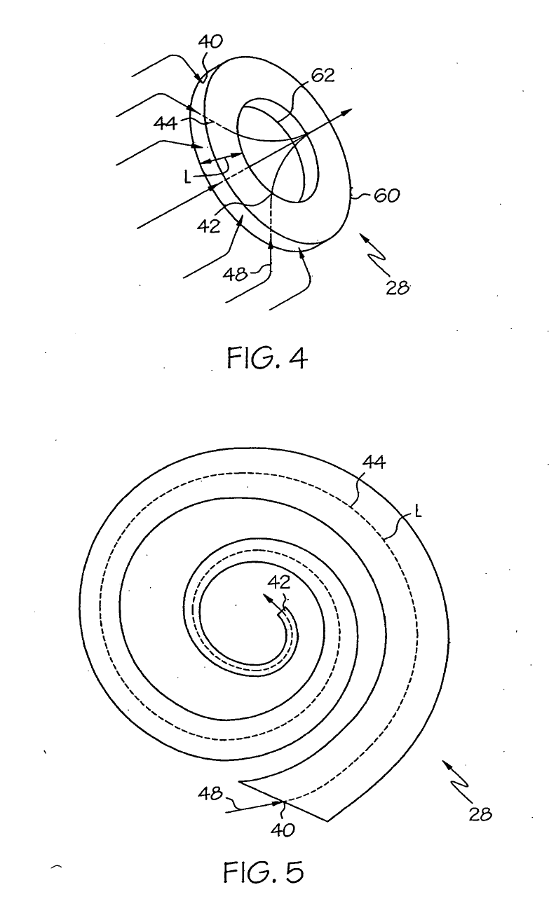

Referring to FIG. 4, the reactor 28 may define an annulus having an outer diameter 60, an inner diameter 62, and a reactant flow path 44 over the annulus extending from the outer diameter 60 to the inner diameter 62. The reactant flow path 44 is generally defined as flowing over or across the annulus, and the annulus may be provided with a preferential oxidation catalyst such that the reactant flow path 44 passes over the preferential oxidation catalyst. It will be understood that a suitable reactant flow structure would be provided to direct the reactant flow path 44 across the annulus from the inlet 40 to the outlet 42. Additionally, a suitable reactant flow structure would be provided to direct the reactant stream 48 to the inlet 40 and from the outlet 42. The inlet 40 is illustrated schematically as being the point where the reactant stream 48 passes over the outer diameter 60 of the annulus and the outlet 42 is illustrated as the point where the reactant stream 48 passes past the inner diameter 62 of the annulus. In this manner, the GHSV increases along the reactant flow path 44 from the inlet 40 to the outlet 42 and the volume of the reactant flow path 44 decreases from the inlet 40 to the outlet 42. It will be understood that a plurality of annuli may be arranged adjacent to one another in a structural relationship such that the reactant stream 48 is directed to flow over the plurality of annuli.

Referring to FIG. 5, the reactor 28 may define a spiral shape between the inlet 40 and the outlet 42, and the reactant flow path 44 may extend along the spiral shape from the inlet 40 to the outlet 42. The spiral shape may be configured such that a volume of the reactant flow path 44 taken along a predetermined length of the reactant flow path 44 decreases along the reactant flow path 44 between the inlet 40 and the outlet 42. Additionally, the spiral shape may be configured such that a volume of the reactant flow path 44 taken along a predetermined length of the reactant flow path 44 continuously decreases along the reactant flow path 44 between the inlet 40 and the outlet 42. The spiral shape may comprise an inward spiral. Alternatively, the spiral shape may comprise any other suitable spiral or similar shape.

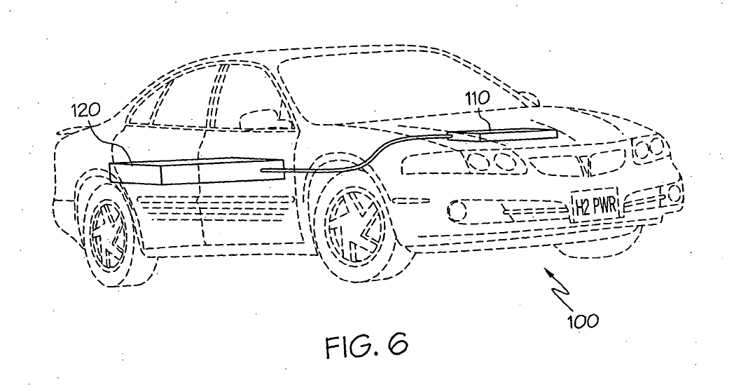

Referring to FIG. 6, the present invention may further comprise a vehicle body 100 and an electrochemical catalytic reaction cell comprising a fuel cell 110. The fuel cell 110 may be configured to at least partially provide the vehicle body with motive power. The vehicle 100 may also have a fuel processing system 120 to supply the fuel cell 110 with hydrogen, and the fuel processing system may include a reactor 28 and a primary reactor 10 as discussed herein. It will be understood by those having skill in the art that fuel cell 110 and fuel processing system 120 are shown schematically and may be used or placed in any suitable manner within the vehicle body 100.

Unless otherwise indicated, all numbers expressing quantities, properties such as molecular weight, reaction conditions, and so forth as used in the specification and claims are to be understood as being modified in all instances by the term “about.” Accordingly, unless otherwise indicated, the numerical properties set forth in the following specification and claims are approximations that may vary depending on the desired properties sought to be obtained in embodiments of the present invention. Notwithstanding that the numerical ranges and parameters setting forth the broad scope of the invention are approximations, the numerical values set forth in the specific examples are reported as precisely as possible. Any numerical values, however, inherently contain certain errors necessarily resulting from error found in their respective measurements.

It will be obvious to those skilled in the art that various changes may be made without departing from the scope of the invention, which is not to be considered limited to what is described in the specification.

What is claimed is:

1. A device comprising a reactor defined by a length, an inlet, and an outlet, wherein:
said reactor comprises a reactant flow path between said inlet and said outlet;
said reactor further comprises at least one preferential oxidation catalyst disposed along said length of said reactor;
said reactant flow path is configured such that a reactant stream may flow along said length of said reactor from said inlet to said outlet;
said reactant flow path is configured such that said reactant stream may contact said at least one preferential oxidation catalyst; and
said reactant flow path is configured such that the gas hourly space velocity of said reactor increases along said reactant flow path between said inlet and said outlet.

2. The device as claimed in claim 1 wherein said gas hourly space velocity of said reactor continuously increases along said reactant flow path between said inlet and said outlet.

3. The device as claimed in claim 1 wherein said gas hourly space velocity of said reactor increases linearly along said reactant flow path from said inlet to said outlet.

4. The device as claimed in claim 1 wherein said reactant flow path is configured such that a volume of said reactant flow path taken along a predetermined length of said flow path decreases along said reactant flow path between said inlet and said outlet.

5. The device as claimed in claim 1 wherein a cross sectional area of said reactant flow path decreases from said inlet and to said outlet.

6. The device as claimed in claim 1 wherein said reactor is configured such that said reactant stream is characterized by a residence time profile along said reactant flow path, and wherein a residence time value of said residence time profile decreases along said reactant flow path from said inlet to said outlet.

7. The device as claimed in claim 1 wherein a cross sectional area of said inlet is greater than a cross sectional area of said outlet.

8. The device as claimed in claim 1 wherein said reactor defines a conical shape between said inlet and said outlet, and wherein said reactant flow path extends along said conical shape from said inlet to said outlet.

9. The device as claimed in claim 8 wherein said conical shape comprises a flat cone.

10. The device as claimed in claim 8 wherein said conical shape defines a taper angle θ of between about 75° and about 85°.

11. The device as claimed in claim 8 wherein said conical shape defines a taper angle θ less than about 90°.

12. The device as claimed in claim 8 wherein said conical shape defines a taper angle θ less than about 85°.

13. The device as claimed in claim 1 wherein said reactor defines a pyramidal shape between said inlet and said outlet, and wherein said reactant flow path extends along said pyramidal shape from said inlet to said outlet.

14. The device as claimed in claim 1 wherein said reactor defines a curved conical shape between said inlet and said outlet, and wherein said reactant flow path extends along said curved conical shape from said inlet to said outlet.

15. The device as claimed in claim 1 wherein said reactor defines at least one annulus between said inlet and said outlet, and wherein said reactant flow path extends over said at least one annulus between said inlet and said outlet.

16. The device as claimed in claim 15 wherein said annulus defines an outer diameter and an inner diameter, and wherein said reactant flow path extends over said annulus from said outer diameter to said inner diameter.

17. The device as claimed in claim 1 wherein said reactor defines a spiral shape between said inlet and said outlet, and wherein said reactant flow path extends along said spiral shape from said inlet to said outlet.

18. The device as claimed in claim 17 wherein said spiral shape is configured such that a volume of said reactant flow path taken along a predetermined length of said reactant flow path decreases along said reactant flow path between said inlet and said outlet.

19. The device as claimed in claim 17 wherein said spiral shape is configured such that a volume of said reactant flow path taken along a predetermined length of said reactant flow path continuously decreases along said reactant flow path between said inlet and said outlet.

20. The device as claimed in claim 17 wherein said spiral shape comprises an inward spiral.

21. The device as claimed in claim 1 wherein said device further comprises a fuel cell stack provided with a source of hydrogen gas and a fuel processing system for providing said hydrogen gas, said fuel processing system comprising a primary reactor and said reactor, wherein said primary reactor is disposed to provide a reactant stream comprising hydrogen and carbon monoxide to said reactor.

22. The device as claimed in claim 1 wherein said device further comprises:
a vehicle body;
a fuel cell stack provided with a source of hydrogen gas, wherein said fule cell stack at least partially provides said vehicle body with motive power; and
a fuel processing system for providing said hydrogen gas, said fuel processing system comprising a primary reactor and said reactor, wherein said primary reactor is disposed to provide a reactant stream comprising hydrogen and carbon monoxide to said reactor.

23. A method for removing carbon monoxide from a reactant stream, comprising:
providing a reactor defined by a length, an inlet, and an outlet, wherein:—
said reactor comprises a reactant flow path between said inlet and said outlet;
said reactor further comprises at least one preferential oxidation catalyst disposed along the length of said reactor;
said reactant flow path is configured such that a reactant stream may flow along said length of said reactor from said inlet to said outlet;
said reactant flow path is configured such that said reactant stream may contact said at least one preferential oxidation catalyst; and
said reactant flow path is configured such that the gas hourly space velocity of said reactor increases along said reactant flow path between
said inlet and said outlet; and
flowing a reactant stream comprising carbon monoxide, hydrogen, and oxygen through said reactor from said inlet to said outlet such that the concentration of carbon monoxide in said reactant stream is reduced between said inlet and said outlet.

24. A preferential oxidation reactor, comprising a reactor defined by a length, an inlet, and an outlet, wherein:
said reactor comprises a reactant flow path between said inlet and said outlet;
said reactor further comprises at least one preferential oxidation catalyst disposed along the length of said reactor;
said reactant flow path is configured such that a reactant stream may flow along said length of said reactor from said inlet to said outlet;
said reactant flow path is configured such that said reactant stream may contact said at least one preferential oxidation catalyst;
said reactant flow path is configured such that the gas hourly space velocity of said reactor increases along said reactant flow path between said inlet and said outlet;
said reactor defines a conical shape between said inlet and said outlet;
said reactant flow path extends along said conical shape from said inlet to said outlet; and
said conical shape defines a taper angle θ of between about 75° and about 85°.
